(19) United States
(12) Patent Application Publication
(10) Pub. No.: US 2013/0225757 A1
(43) Pub. Date: Aug. 29, 2013

(54) RUBBER COMPOSITION FOR TIRE SIDEWALL AND PNEUMATIC TIRE

(71) Applicant: TOYO TIRE & RUBBER CO., LTD., (US)

(72) Inventor: Kohei Matsuura, Osaka-shi (JP)

(73) Assignee: TOYO TIRE & RUBBER CO., LTD., Osaka (JP)

(21) Appl. No.: 13/718,265

(22) Filed: Dec. 18, 2012

(30) Foreign Application Priority Data
Feb. 29, 2012 (JP) 2012-044047

(51) Int. Cl. C08L 7/00

(52) U.S. Cl. CPC C08L 7/00
USPC 524/526

(57) ABSTRACT

A rubber composition for a tire sidewall includes 100 parts by mass of a rubber component comprising from 40 to 70% by mass of natural rubber and/or an isoprene rubber, and from 60 to 30% by mass of a butadiene rubber having 96% or more of cis-1,4 bond content, polymerized using a rare earth element-based catalyst, from 25 to 50 parts by mass of a filler comprising carbon black and/or silica, and from 0.3 to 3 parts by mass of a vulcanization accelerator, wherein the vulcanization accelerator comprises from 0.1 to 1.5 parts by mass of a sulfenimide compound represented by the following formula (1) and a sulfenamide-based vulcanization accelerator;

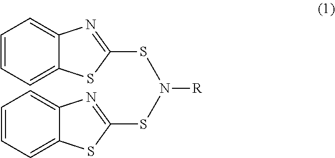

wherein R represents a hydrocarbon group having from 1 to 18 carbon atoms.

### CROSS-REFERENCE TO RELATED APPLICATIONS

This application is based upon and claims the benefit of priority from the prior Japanese Patent Application No. 2012-44047, filed on Feb. 29, 2012; the entire contents of which are incorporated herein by reference.

### BACKGROUND

1. Technical Field

The disclosure relates to a rubber composition for a tire sidewall used in a sidewall part of a pneumatic tire, and a pneumatic tire using the same.

2. Related Art

Low fuel consumption of automobiles is recently increasing demand. Tire is desired to achieve low fuel consumption and is required to reduce rolling resistance. A method for reducing rolling resistance includes a method for making a rubber composition constituting a tire harder to generate heat, that is, a method of improving low heat generation performance.

One method of improving low heat generation performance is that an amount of a vulcanization accelerator added to a rubber composition is increased. However, where the amount of a vulcanization accelerator is increased, resistance to fatigue from flexing that is one of the characteristics needed in a sidewall part is deteriorated. Furthermore, there is a problem of concern that vulcanization rate is increased and scorch performance is deteriorated, thereby rubber scorch and the like occur in an extrusion step. Additionally, there is a problem of concern that rigidity of a vulcanizate is increased, thereby tear resistance performance is deteriorated.

JP-A-2006-124487 (KOKAI) discloses a rubber composition for a tire sidewall, in which a butadiene rubber polymerized using a neodymium-based catalyst, specific silica and specific carbon black are concurrently used. JP-A-2006-124487 (KOKAI) further discloses that the concurrent use reduces rolling resistance of a tire without damaging resistance to fatigue from flexing, cut resistance performance, and process performance when manufacturing a tire.

On the other hand, JP-A-2009-155632 (KOKAI) discloses a rubber composition for breaker topping, in which N-tert-butyl-2-benzothiazolyl sulfenimide is added as a vulcanization accelerator together with a modified butadiene rubber or a modified styrene-butadiene rubber. JP-A-2009-155632 (KOKAI) further discloses that a sulfenamide-based vulcanization accelerator is used together with the sulfenimide. Furthermore, JP-A-2010-280782 (KOKAI) discloses a rubber composition for tread cushion, in which a sulfenamide-based vulcanization accelerator is used as a vulcanization accelerator together with N-tert-butyl-2-benzothiazolyl sulfenimide. However, those publications relate to a rubber composition that is provided in the inside of a tire and is required to develop adhesion, and do not suggest application to a sidewall part.

JP-A-2011-126930 (KOKAI) discloses a rubber composition for a tire, in which benzothiazolyl sulfenimide is used as a vulcanization accelerator together with silica and a specific silane coupling agent, thereby improving low fuel consumption performance and driving stability performance. JP-A-2011-126930 (KOKAI) further discloses that a sulfenamide-based vulcanization accelerator can be used together with benzothiazolyl sulfenimide. However, JP-A-2011-126930 (KOKAI) relates to undertread and wing among tire members, and does not disclose the advantageous effect due to the use of the rubber composition in a sidewall part.

On the other hand, JP-A-2006-297733 (KOKAI) discloses a rubber composition used in a sidewall part of a tire, in which N-tert-butyl-2-benzothiazolyl sulfenimide is used as a vulcanization accelerator. However, JP-A-2006-297733 (KOKAI) does not disclose the advantageous effect due to the concurrent use of a sulfenimide compound and a sulfenamide-based vulcanization accelerator in a specific rubber component.

### SUMMARY

A rubber composition for a tire sidewall according to an embodiment comprises: 100 parts by mass of a rubber component comprising from 40 to 70% by mass of natural rubber and/or an isoprene rubber, and from 60 to 30% by mass of a butadiene rubber having 96% or more of cis-1,4 bond content, polymerized using a rare earth element-based catalyst; from 25 to 50 parts by mass of a filler comprising carbon black and/or silica; and from 0.3 to 3 parts by mass of a vulcanization accelerator. The vulcanization accelerator comprises from 0.1 to 1.5 parts by mass of a sulfenimide compound represented by the following formula (1) and a sulfenamide-based vulcanization accelerator;

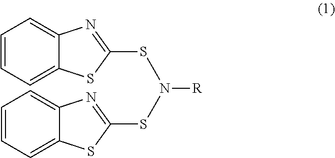

wherein R represents a hydrocarbon group having from 1 to 18 carbon atoms.

A pneumatic tire according to an embodiment is a pneumatic tire having a sidewall part comprising the rubber composition.

### DETAILED DESCRIPTION

According to an embodiment, the sulfenimide compound and the sulfenamide-based vulcanization accelerator are concurrently used as vulcanization accelerators in the rubber composition comprising the rubber component comprising natural rubber and/or an isoprene rubber, and a specific butadiene rubber polymerized with a rare earth element-based catalyst. The concurrent use can improve low heat generation performance and additionally can improve tear resistance performance without damaging process performance when manufacturing a tire, and resistance to fatigue from flexing.

In the rubber composition according to an embodiment, the rubber component comprises (A) from 40 to 70% by mass of natural rubber and/or an isoprene rubber, and (B) from 60 to 30% by mass of a butadiene rubber having 96% or more of cis-1, 4 bond content, polymerized using a rare earth element-based catalyst.

The natural rubber (NR) and isoprene rubber (IR) in the component (A) are not particularly limited, and can use rubbers generally used in rubber industries. The component (A) may be natural rubber alone, an isoprene rubber alone, or a blend of natural rubber and isoprene rubber.

When the content of natural rubber and/or isoprene rubber in the rubber component is 40% by mass or more, the effect of improving low heat generation performance and the effect of improving tear resistance performance can be exhibited. The content is more preferably 50% by mass or more. The content of natural rubber and/or isoprene rubber is 70% by mass or less, and more preferably 60% by mass or less, for the reasons that the content of the component (B) is ensured, thereby maintaining resistance to fatigue from flexing.

The butadiene rubber of the component (B) is a polybutadiene rubber polymerized using a rare earth element-based catalyst (hereinafter referred to as “rare earth element-based catalyst BR”). The rare earth element-based catalyst is preferably a neodymium-based catalyst, and examples of the neodymium-based catalyst include neodymium element, compounds of neodymium and other metals, and organic compounds. More specifically, specific examples of the neodymium catalyst include NdCl₃ and Et-NdCl₂.

The butadiene rubber synthesized with the rare earth element-based catalyst generally has a microstructure having high cis content and low vinyl content, and can reduce hysteresis loss of vulcanized rubber as compared with a butadiene rubber synthesized with other catalysts including a cobalt catalyst. In the embodiments, the butadiene rubber having 96% or more of cis-1,4 bond content is used, and hysteresis loss of a vulcanized rubber can be reduced. The microstructure of the rare earth element-based catalyst BR is preferably that the cis-1,4 bond content is 96% or more and a vinyl group (1,2-vinyl bond) content is 1.0% or less. The cis-1,4 bond content and vinyl group content are values calculated from integration ratio of ¹HNMR spectrum.

When the content of the rare earth element-based catalyst BR in the rubber component is 30% by mass or more, deterioration of resistance to fatigue from flexing can be suppressed. The content of the rare earth element-based catalyst BR is more preferably 40% by mass or more. The content of the rare earth element-based catalyst BR is 60% by mass or less, and more preferably 50% by mass or less, in order to ensure the content of the component (A) and to exhibit the effect of improving low heat generation performance and the effect of improving tear resistance performance.

The rubber component in the embodiments basically comprises a blend of the component (A) and the component (B), but may contain other rubbers in an amount that the above-described effects are not impaired. The other rubbers are not particularly limited. Examples of the other rubbers include diene rubbers such as a styrene-butadiene rubber (SBR), a butadiene rubber (BR) polymerized with catalysts other than a rare earth element-based catalyst, an acrylonitrile-butadiene rubber (NBR) and a chloroprene rubber (CR).

The rubber composition according to the embodiments contains carbon black and/or silica as a filler. The total amount of the carbon black and/or silica added is from 25 to 50 parts by mass per 100 parts by mass of the rubber component. Thus, a rubber composition for a sidewall, having low filler content in which the amount of the filler added is decreased is advantageous to the improvement of low heat generation performance. The content of the filler added is more preferably from 30 to 45 parts by mass per 100 parts by mass of the rubber component.

The carbon black preferably used has iodine adsorption (IA) of from 30 to 100 mg/g and DBP (dibutyl phthalate) oil absorption of from 90 to 160 ml/100 g. The iodine adsorption is a value measured according to JIS K6217. Use of the carbon black having the value of 30 mg/g or more can improve tear resistance performance. Furthermore, use of the carbon black having the iodine adsorption of 100 mg/g or less can enhance the effect of improving low heat generation performance. The DBP oil absorption is measured according to JIS K6217 and is an index of structure of carbon black. Use of the carbon black having DBP oil adsorption of 90 ml/100 g or more is advantageous to maintain resistance to fatigue from flexing. The DBP oil absorption is more preferably from 100 to 130 ml/100 g.

The silica that can be used includes wet silica (hydrous silicic acid), dry silica (anhydrous silicic acid) and surface-treated silica. Of those, wet silica is preferably used. BET specific surface area (measured according to BET method defined in JIS K6430) of silica is not particularly limited, but is preferably from 90 to 220 m²/g, and more preferably from 150 to 220 m²/g.

The filler may be carbon black alone, silica alone or a mixture of carbon black and silica. Use of carbon black alone or a mixture of carbon black and silica is preferred. The carbon black is used in an amount of preferably from 10 to 50 parts by mass, and more preferably from 15 to 45 parts by mass, per 100 parts by mass of the rubber component. When the silica is added, the amount of the silica added is preferably 15 parts by mass or less, and more preferably from 3 to 8 parts by mass, per 100 parts by mass of the rubber component. Addition of the silica can further improve low heat generation performance. Addition of the silica in an amount of 15 parts by mass or less can suppress deterioration of process performance, while maintaining low heat generation performance.

When the silica is added, a silane coupling agent is preferably concurrently used in order to improve dispersibility of silica. The amount of the silane coupling agent added is preferably from 5 to 15 parts by mass, per 100 parts by mass of the silica. The silane coupling agent is not particularly limited, and examples thereof include sulfide silanes such as bis(3-triethoxysilylpropyl)tetrasulfide, bis(3-triethoxysilylpropyl)disulfide and bis(2-triethoxysilylethyl)tetrasulfide; and protected mercaptosilanes such as 3-octanoylthio-1-propyl triethoxysilane and 3-propionylthiopropyl trimethoxysilane.

The rubber composition according to the embodiments uses a sulfenimide compound represented by the following formula (1):

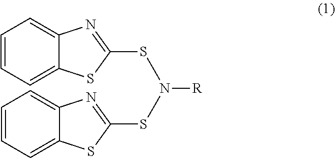

and a sulfenamide-based vulcanization accelerator in combination as a vulcanization accelerator.

In the formula (1) of the sulfenimide compound, R represents a hydrocarbon group having from 1 to 18 carbon atoms. Examples of the hydrocarbon group include a straight-chain alkyl group, a branched-chain alkyl group, an alicyclic hydrocarbon group and an aromatic hydrocarbon group. The carbon number in the hydrocarbon group is preferably from 1 to 16, more preferably from 3 to 16, and still more preferably from 4 to 12. Specific examples of the hydrocarbon group R include tert-butyl group, 2-ethylhexyl group, 2-methylhexyl group, 3-ethylhexyl group, 3-methylhexyl group, 2-ethylpropyl group, 2-ethylbutyl group, 2-ethylpentyl group, 2-ethylheptyl group, 2-ethyloctyl group and cyclohexyl group. Of these groups, tert-butyl group is preferably used. In other words, the preferred example of the sulfenimide compound includes N-tert-butyl-2-benzothiazolyl sulfenimide represented by the following formula (2). These sulfenimide compounds may be used in one kind alone or as a mixture of two kinds or more.

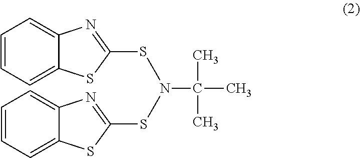 [SMILES: CC(C)(C)N(Sc1nc2ccccc2s1)Sc1nc2ccccc2s1]

Examples of the sulfenamide-based vulcanization accelerator used in combination with the sulfenimide compound include N-cyclohexyl-2-benzothiazolyl sulfenamide (CZ, JIS abbreviation: CBS), N-tert-butyl-2-benzothiazolyl sulfenamide (NS, JIS abbreviation: BBS), N,N-dicyclohexyl-2-benzothiazolyl sulfenamide (DZ, JIS abbreviation: DCBS), N-oxydiethylene-2-benzothiazolyl sulfenamide (OBS), N,N-diisopropyl-2-benzothiazolyl sulfenamide (DPBS), N,N-di(2-ethylhexyl)-2-benzothiazolyl sulfenamide and N,N-di(2-methylhexyl)-2-benzothiazolyl sulfenamide. These sulfenamide-based vulcanization accelerators may be used in one kind alone or as a mixture of two kinds or more.

The amount of the vulcanization accelerator added is that the amount of the sulfenimide compound added is from 0.1 to 1.5 parts by mass per 100 parts by mass of the rubber component. Where the amount of the sulfenimide compound added is less than 0.1 parts by mass, its addition effect is not sufficiently obtained. On the other hand, where the amount of the sulfenimide compound added exceeds 1.5 parts by mass, the effect of improving low heat generation performance is obtained, but the effect of improving tear resistance performance is impaired. The amount of the sulfenimide compound added is preferably from 0.2 to 1.0 part by mass per 100 parts by mass of the rubber component.

The total amount of the vulcanization accelerators including the sulfenimide compound is from 0.3 to 3 parts by mass per 100 parts by mass of the rubber component. Where the amount of the vulcanization accelerators added exceeds 3 parts by mass, scorch performance is deteriorated, thereby process performance when manufacturing a tire may be impaired. The amount of the vulcanization accelerators added is more preferably from 0.5 to 1.5 parts by mass per 100 parts by mass of the rubber component. The amount of the sulfenamide-based vulcanization accelerator added is defined by the relationship between the total amount of the vulcanization accelerators and the amount of the sulfenimide compound added, and is preferably from 0.1 to 1.5 parts by mass, and more preferably from 0.2 to 1.0 part by mass, per 100 parts by mass of the rubber component.

The rubber composition according to the embodiments can contain various additives generally used in a rubber composition for a tire sidewall, such as zinc flower, stearic acid, an age resistor, a softener, a wax and a vulcanizing agent, in addition to the above-described components. Examples of the vulcanizing agent include sulfur and a sulfur-containing compound. Although not particularly limited, the amount of the vulcanizing agent added is preferably from 0.1 to 10 parts by mass, and more preferably from 0.5 to 5 parts by mass, per 100 parts by mass of the rubber component.

The rubber composition can be prepared by kneading according to the conventional methods using a mixing machine generally used, such as Banbury mixer, a kneader or a roll. Specifically, the rubber composition can be prepared by adding the filler and other additives excluding a vulcanizing agent and a vulcanization accelerator, to a rubber component, followed by mixing, in a first mixing step, and adding a vulcanizing agent and a vulcanization accelerator to the mixture obtained, followed by mixing, in a final mixing step.

The rubber composition for a tire sidewall having the above constitution according to the embodiments is preferably that loss tangent tan δ of a vulcanizate of the rubber composition measured under initial strain: 15%, dynamic strain: ±2.5%, frequency: 10 Hz and temperature: 60° C. is from 0.050 to 0.100. When the tan δ is 0.100 or less, low heat generation performance is improved, thereby low fuel consumption performance of a pneumatic tire can be improved. The tan δ is more preferably 0.085 or less. The tan δ of a vulcanizate varies depending on kind and addition amount of the carbon black, addition amount of a vulcanization accelerator, particularly a sulfenimide compound, and the like. For example, the tan δ increases with increasing iodine adsorption of the carbon black and with increasing the addition amount of the carbon black. Furthermore, the tan δ decreases with increasing the total amount of vulcanization accelerators and the addition amount of the sulfenimide compound.

The rubber composition for a tire sidewall according to the embodiments as described above is used as a rubber composition for a sidewall part of a pneumatic tire, and can form the sidewall part by vulcanization molding according to the conventional methods. The pneumatic tire is not particularly limited, and includes various tires such as a radial tire for passenger vehicles, a heavy load tire used in large-sized vehicles such as trucks and buses, and the like.

Examples are described below, but it should be understood that the invention is not limited to these Examples.

Components excluding sulfur and a vulcanization accelerator were mixed using Banbury mixer according to the formulations (pasts by mass) shown in Tables 1 and 2 below in a first mixing step. Sulfur and a vulcanization accelerator were mixed with the resulting mixture in a final mixing step to prepare a rubber composition for a tire sidewall. Details of each component in Tables 1 and 2 are as follows.

NR: Natural rubber (RSS #3)

Co—BR: BR150B (butadiene rubber polymerized using cobalt-based catalyst) manufactured by Ube Industries, Ltd.

Nd—BR: Buna CB22 (butadiene rubber polymerized using neodymium-based catalyst, cis-1,4 bond content: 96.5%, vinyl group content: 0.4%) manufactured by LANXESS

Carbon black 1: FEF, SEAST SO (iodine adsorption: 44 mg/g, DBP oil absorption: 115 ml/100 g) manufactured by Tokai Carbon Co., Ltd.

Carbon black 2: HAF, SEAST KH (iodine adsorption: 90 mg/g, DBP oil absorption: 119 ml/100 g) manufactured by Tokai Carbon Co., Ltd.

Carbon black 3: ISAF, SEAST 6 (iodine adsorption: 121 mg/g, DBP oil absorption: 114 ml/100 g) manufactured by Tokai Carbon Co., Ltd.

Silica: NIPSIL AQ (BET specific surface area: 205 m²/g) manufactured by Tosoh Silica Corporation

Silane coupling agent: Si69 manufactured by Degussa

CBS: Sulfenamide-based vulcanization accelerator, N-cyclohexyl-2-benzothiazolyl sulfenamide, SOXINOL CZ manufactured by Sumitomo Chemical Co., Ltd.

BBS: Sulfenamide-based vulcanization accelerator, N-tert-butyl-2-benzothiazolyl sulfenamide, NOCCELER NS-P manufactured by Ouchi Shinko Chemical Industrial Co., Ltd.

MBTS: Thiazole-based vulcanization accelerator, dibenzothiazyl disulfide, SANCELER DM-G manufactured by Sanshin Chemical Industry Co., Ltd.

TBSI: Sulfenimide compound, N-tert-butyl-2-benzothiazolyl sulfenimide, SANTOCURE TBSI manufactured by Flexis

Parts by mass of zinc flower (Zinc Flower #1 manufactured by Mitsui Mining & Smelting Co., Ltd.), 2 parts by mass of stearic acid (LUNAC S-20 manufactured by Kao Corporation), 1 part by mass of a wax (OZOACE 0355 manufactured by Nippon Seiro Co., Ltd.), 3 parts by mass of an oil (PROCESS P200 manufactured by JOMO), 3 parts by mass of an age resister (NOCRAC 6C manufactured by Ouchi Shinko Chemical Industrial Co., Ltd.) and 2 parts by mass of sulfur (powdered sulfur manufactured by Tsurumi Chemical Industry Co., Ltd.) were added as common formulation to 100 parts by mass of a rubber component in each rubber composition.

Vulcanization rate t90 and scorch performance were measured in each rubber composition, and using a test piece having a given shape vulcanized at 150° C. for 30 minutes, tan (low heat generation performance), tear strength and resistance to fatigue from flexing were measured and evaluated. Each measurement and evaluation method is as follows. The results obtained are shown in Tables 1 and 2.

Tan δ: Tan δ of a test piece having a width of 5 mm, a length of 30 mm and a thickness of 1 mm was measured under the conditions of initial strain: 15%, dynamic strain: ±2.5%, frequency: 10 Hz and temperature: 60° C. using a viscoelastometer manufactured by UBM. Generation of heat is difficult to occur and low heat generation performance is excellent as the value of tan δ is small.

Tear strength: Tear strength was measured according to JIS K6252 (crescent-shaped test piece), and indicated by an index in a manner such that the value of Comparative Example 1 is 100. Tear strength is high and tear resistance performance is excellent as the index is large.

t90: Mooney scorch test according to JIS K6300 was conducted using a rheometer (L-shaped rotor), and t90 value (min) when measured at a temperature of 150° C. for a preheating time of 1 minute was obtained. Vulcanization rate is fast as the value is small.

Scorch performance: Mooney scorch test according to JIS K6300 was conducted using a rheometer (L-shaped rotor), t5 value (min) when measured at a temperature of 125° C. for a preheating time of 1 minute was obtained, and scorch performance was indicated by an index in a manner such that the value of Comparative Example 1 is 100. Scorch is difficult to occur and scorch performance is excellent as the index is large.

Resistance to fatigue from flexing: Measured according to JIS K6260. Comparative Example 1 was used as Control. When resistance to fatigue from flexing was the same as or more than that of Comparative Example 1, it was evaluated as “Good”, and when inferior to that of Comparative Example 1, it was evaluated as “Poor”.

TABLE 1

| | | Example 1 | Example 2 | Example 3 | Example 4 | Example 5 | Example 6 | Example 7 | Example 8 |
|---|---|---|---|---|---|---|---|---|---|
| Formulation | NR | 50 | 50 | 60 | 60 | 60 | 60 | 60 | 60 |
| (Parts by | Co—BR | | | | | | | | |
| mass) | Nd—BR | 50 | 50 | 40 | 40 | 40 | 40 | 40 | 40 |
| | Carbon black 1 | 35 | 35 | 35 | | | 25 | 15 | 45 |
| | Carbon black 2 | | | | 35 | | | | |
| | Carbon black 3 | | | | | 30 | | | |
| | Silica | | | | | | 5 | 15 | |
| | Silane | | | | | | | | |
| | coupling agent | | | | | | 0.5 | 1.5 | |
| | CBS | 0.8 | 0.5 | 0.2 | 0.8 | 0.8 | 0.8 | 0.8 | 0.5 |
| | BBS | | | | | | | | |
| | MBTS | | | | | | | | |
| | TBSI | 0.2 | 0.5 | 1.0 | 0.2 | 0.2 | 0.2 | 0.2 | 0.5 |

| | | | | | | | | |
|---|---|---|---|---|---|---|---|---|
| Low heat generation | 0.083 | 0.081 | 0.078 | 0.079 | 0.079 | 0.079 | 0.075 | 0.083 |
| performance: tan δ | | | | | | | | |
| Tear strength (index) | 115 | 110 | 107 | 117 | 116 | 116 | 121 | 121 |
| t90 (min) | 16.0 | 16.7 | 13.0 | 15.3 | 15.2 | 15.5 | 16.0 | 15.0 |
| Scorch performance (index) | 104 | 108 | 96 | 105 | 105 | 106 | 110 | 100 |
| Resistance to fatigue from | Good | Good | Good | Good | Good | Good | Good | Good |
| flexing | | | | | | | | |

TABLE 2

| | | Comparative | Comparative | Comparative | Comparative | Comparative | Comparative | Comparative |
|---|---|---|---|---|---|---|---|---|
| | | Example 1 | Example 2 | Example 3 | Example 4 | Example 5 | Example 6 | Example 7 |
| Formulation | NR | 50 | 50 | 50 | 50 | 60 | 50 | 50 |
| (Parts by | Co—BR | | | | | | | |
| mass) | Nd—BR | 50 | 50 | 50 | 50 | 40 | 50 | 50 |
| | Carbon black 1 | 35 | 35 | 35 | 35 | 35 | 35 | 35 |
| | Carbon black 2 | | | | | | | |
| | Carbon black 3 | | | | | | | |
| | Silica | | | | | | | |
| | Silane coupling | | | | | | | |
| | agent | | | | | | | |
| | CBS | 1.0 | 1.4 | | 0.1 | | 0.8 | 0.8 |
| | BBS | | | | | | 0.2 | |
| | MBTS | | | | | 0.8 | | 0.2 |
| | TBSI | | | 1.0 | 2.0 | 0.2 | | |
| Low heat generation | | 0.092 | 0.076 | 0.103 | 0.074 | 0.097 | 0.085 | 0.099 |
| performance: tan δ | | | | | | | | |
| Tear strength (index) | | 100 | 80 | 115 | 75 | 114 | 101 | 110 |
| t90 (min) | | 14.0 | 11.0 | 16.0 | 10.5 | 16.5 | 14.5 | 15.0 |
| Scorch performance (index) | | 100 | 88 | 108 | 85 | 100 | 102 | 104 |
| Resistance to fatigue from | | — | Poor | Good | Poor | Good | Good | Good |
| flexing | | | | | | | | |
| | | Comparative | Comparative | Comparative | Comparative | Comparative | Comparative | Comparative |
| | | Example 8 | Example 9 | Example 10 | Example 11 | Example 12 | Example 13 | Example 14 |
| Formulation | NR | 50 | 50 | 50 | 100 | 80 | 30 | 50 |
| (Parts by | Co—BR | | | | | | | 50 |
| mass) | Nd—BR | 50 | 50 | 50 | | 20 | 70 | |
| | Carbon black 1 | 60 | 20 | 45 | 35 | 35 | 35 | 40 |
| | Carbon black 2 | | | | | | | |
| | Carbon black 3 | | | | | | | |
| | Silica | | | 10 | | | | |
| | Silane | | | 1.0 | | | | |
| | coupling agent | | | | | | | |
| | CBS | 0.8 | 0.8 | 0.8 | 0.8 | 0.8 | 0.8 | 0.8 |
| | BBS | | | | | | | |
| | MBTS | | | | | | | |
| | TBSI | 0.2 | 0.2 | 0.2 | 0.2 | 0.2 | 0.2 | 0.2 |

| | | | | | | | |
|---|---|---|---|---|---|---|---|
| Low heat generation | 0.108 | 0.075 | 0.105 | 0.075 | 0.077 | 0.099 | 0.110 |
| performance: tan δ | | | | | | | |
| Tear strength (index) | 138 | 104 | 135 | 138 | 124 | 104 | 116 |
| t90 (min) | 15.0 | 18.0 | 18.7 | 15.0 | 15.5 | 17.0 | 15.7 |
| Scorch performance (index) | 96 | 108 | 109 | 100 | 102 | 108 | 102 |
| Resistance to fatigue from | Good | Poor | Good | Poor | Poor | Good | Good |
| flexing | | | | | | | |

The results are shown in Tables 1 and 2 above. As compared with Comparative Example 1 that is Control, Examples 1 to 8 were such that tan δ was small, low heat generation performance was improved, and tear resistance performance was improved. Furthermore, vulcanization rate and scorch performance were comparable with those of Comparative Example 1, and deterioration of process performance when manufacturing a tire was not involved. Additionally, resistance to fatigue from flexing was maintained.

On the other hand, in Comparative Example 2 in which an amount of a sulfenamide-based vulcanization accelerator was merely increased as compared with Comparative Example 1, although low heat generation performance was improved, tear resistance performance was deteriorated and resistance to fatigue from flexing was impaired. In Comparative Example 3 in which a sulfenamide-based vulcanization accelerator was replaced by a sulfenimide compound, tear resistance performance was improved, but low heat generation performance was deteriorated. In Comparative Example 4 in which the amount of a sulfenimide compound was too large, low heat generation performance was improved, but tear resistance performance was deteriorated and resistance to fatigue from flexing was impaired. In Comparative Example 5 in which a sulfenimide compound and a thiazol-based vulcanization accelerator were concurrently used, tear resistance performance was improved, but low heat generation performance was deteriorated. In Comparative Example 6 in which two kinds of sulfenamide-based vulcanization accelerators of CBS and BBS were concurrently used, the effect of improving low heat generation performance was observed as compared with Comparative Example 1, but the improvement of tear resistance performance was not obtained. In Comparative Example 7 in which a sulfenamide-based vulcanization accelerator and a thiazol-based vulcanization accelerator were concurrently used, the effect of improving tear resistance performance was observed, but the effect of improving low heat generation performance was not obtained.

In Comparative Example 8 in which carbon black was added in larger amount as compared with Comparative Example 1, tear resistance performance was improved, but low heat generation performance was greatly deteriorated. On the other hand, in Comparative Example 9 in which the amount of carbon black added was too small, the effect of improving tear resistance performance was insufficient, and resistance to fatigue from flexing was impaired. In Comparative Example 10 in which carbon black and silica were concurrently used, but the amount of those added was too large, tear resistance performance was improved, but the effect of improving low heat generation performance was not obtained.

In Comparative Example 11 in which natural rubber was used alone as a rubber component, low heat generation performance and tear resistance performance were improved, but resistance to fatigue from flexing was poor. Even in Comparative Example 12 in which natural rubber and Nd—BR were concurrently used, but the proportion of natural rubber was too large, the same results as obtained in Comparative Example 11 were obtained. On the other hand, in Comparative Example 13 in which the proportion of Nd—BR was too large, resistance to fatigue from flexing was maintained, but the effects of improving low heat generation performance and tear resistance performance were not obtained. Furthermore, in Comparative Example 14 in which Co—BR was used in place of Nd—BR, resistance to fatigue from flexing was maintained and tear resistance performance was improved, but the effect of improving low heat generation performance was not obtained.

As described above, Examples 1 to 8 in which a sulfenimide compound and a sulfenamide-based vulcanization accelerator were concurrently used in given amounts as vulcanization accelerators together with a rubber component comprising natural rubber and Nb—BR could improve low heat generation performance and additionally could improve tear resistance performance, without damaging process performance and resistance to fatigue from flexing, as compared with Comparative Example 1.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is:

1. A rubber composition for a tire sidewall, comprising:
100 parts by mass of a rubber component comprising from 40 to 70% by mass of natural rubber and/or an isoprene rubber, and from 60 to 30% by mass of a butadiene rubber having 96% or more of cis-1,4 bond content, polymerized using a rare earth element-based catalyst,
from 25 to 50 parts by mass of a filler comprising carbon black and/or silica, and
from 0.3 to 3 parts by mass of a vulcanization accelerator,
wherein the vulcanization accelerator comprises from 0.1 to 1.5 parts by mass of a sulfenimide compound represented by the following formula (1) and a sulfenamide-based vulcanization accelerator; 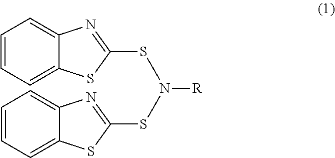
wherein R represents a hydrocarbon group having from 1 to 18 carbon atoms.

2. The rubber composition for a tire sidewall according to claim 1, wherein the filler comprises carbon black having iodine adsorption (IA) of from 30 to 100 mg/g and DBP (dibutyl phthalate) oil absorption of from 90 to 160 ml/100 g.

3. The rubber composition for a tire sidewall according to claim 2, comprising the carbon black in an amount of from 10 to 50 parts by mass per 100 parts by mass of the rubber component.

4. The rubber composition for a tire sidewall according to claim 1, wherein the sulfenimide compound is N-tert-butyl-2-benzothiazolyl sulfenimide.

5. The rubber composition for a tire sidewall according to claim 1, wherein the sulfenamide-based vulcanization accelerator is at least one selected from the group consisting of N-cyclohexyl-2-benzothiazolyl sulfenamide, N-tert-butyl-2-benzothiazolyl sulfenamide, N,N-dicyclohexyl-2-benzothiazolyl sulfenamide, N-oxydiethylene-2-benzothiazolyl sulfenamide, N,N-diisopropyl-2-benzothiazolyl sulfenamide, N,N-di(2-ethylhexyl)-2-benzothiazolyl sulfenamide and N,N-di(2-methylhexyl)-2-benzothiazolyl sulfenamide.

6. The rubber composition for a tire sidewall according to claim 1, wherein the butadiene rubber has 1,2-vinyl bond content of 1.0% or less.

7. The rubber composition for a tire sidewall according to claim 1, having loss tangent tan δ of a vulcanizate measured under initial strain: 15%, dynamic strain: ±2.5%, frequency: 10 Hz and temperature: 60° C., of from 0.050 to 0.100.

8. A pneumatic tire having a sidewall part comprising the rubber composition according to claim 1.
